(19) United States
(12) Patent Application Publication
(10) Pub. No.: US 2002/0179413 A1
(43) Pub. Date: Dec. 5, 2002

(54) Device for collection, translation and release of cardboard blanks

(75) Inventor: Mario Gambetti, Castelfranco Emilia (IT)

Correspondence Address: THE FIRM OF KARL F ROSS, 5676 RIVERDALE AVENUE, PO BOX 900, RIVERDALE (BRONX), NY, 10471-0900, US

(73) Assignee: BAUMER S.r.l.

(21) Appl. No.: 10/154,651

(22) Filed: May 23, 2002

(30) Foreign Application Priority Data
May 29, 2001 (IT) BO2001A000338

(51) Int. Cl. B65G 25/00

(52) U.S. Cl. 198/750.12

(57) ABSTRACT

A device for collection, translation and supply of cardboard blanks (5) from a collection store (2) to a receipt conveyor comprises two rotary elements (10a and 10b) and one or more gripper units (100, 200). Each of the said gripper units (100,200) comprises: a second shaft (114) which is supported such as to rotate idly by the said two rotary units (10a, 10b), and is oscillated by command relative to its own axis (114x) by means of first oscillator means (117, 119) which are activated by means of a first stationary cam (10); a third shaft (123) which is supported such as to rotate idly by means of two or more arms (121a, 121b) and is oscillated by command relative to its own axis (123x) by means of second oscillator means (125, 126, 127, 130, 132) which are activated by means of a second stationary cam (20); one or more gripper means (137a, 137b etc) which are supported by the said third shaft (123).

The present invention relates to a device for collection, translation and release of cardboard blanks.

At present, with particular reference to the field of packaging and/or wrapping machines, various devices are known for collection, translation and release of cardboard blanks, but the said devices are substantially unable to operate quickly with cardboard blanks which have large dimensions.

The object of the present invention is to eliminate the above-described disadvantages.

The invention, which is characterised by the claims, solves the problem of creating a device for collection, translation and supply of flat cardboard blanks from a collection store to a receipt conveyor, comprising two opposite rotary elements which are designed to rotate relative to a first shaft which is disposed between the said store and the said conveyor, and one or more gripper units which are supported by the said two rotary elements, designed to move along an orbit which passes in the vicinity of the said store and in the vicinity of the said conveyor, wherein the said device is characterised in that each of the said gripper units comprises: a second shaft which is supported such as to rotate idly by the said rotary elements, designed to orbit along a circumferential path, wherein the said second shaft is oscillated by command relative to its own axis by first oscillator means which are activated by means of a first stationary cam; a third shaft which is supported such as to rotate idly by means of two or more arms which are secured to the said second shaft and extend radially, wherein the said third shaft is oscillated by command relative to its own axis by second oscillator means which are activated by means of a second stationary cam; and one or more gripper means which are supported by the said third shaft.

The results and advantages which can be obtained by means of the present invention consist in the fact that it is possible to collect, translate and release at high speed cardboard blanks which have large dimensions, with a consequent increase in the production capacity of the corresponding packaging and/or wrapping machines.

Further characteristics and advantages of the present invention will become more apparent from the following description of a preferred practical embodiment, provided purely by way of non-limiting example, with reference to the figures of the attached drawings in which:

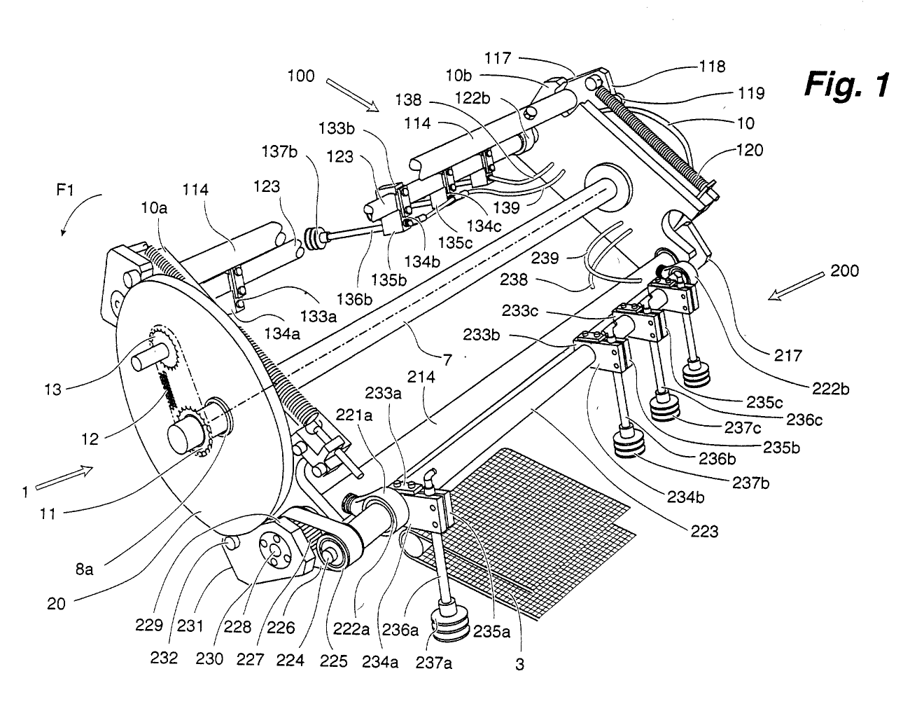

FIG. 1 is a schematic perspective view of the device which is the subject of the present invention;

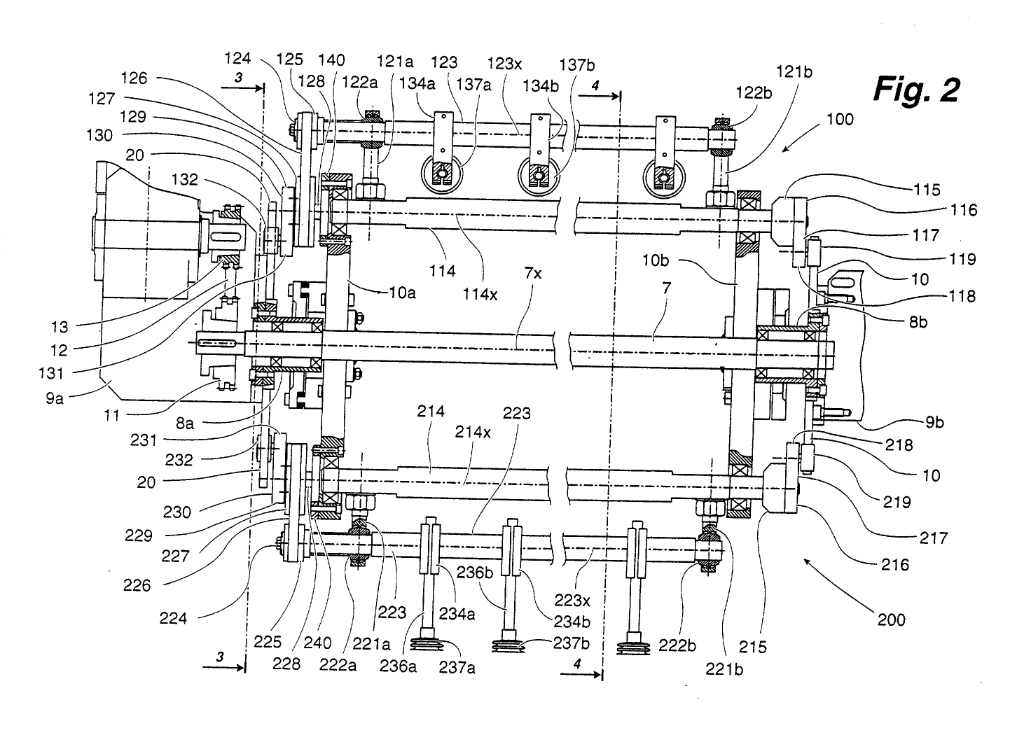

FIG. 2 is a schematic view from the front of the device in FIG. 1;

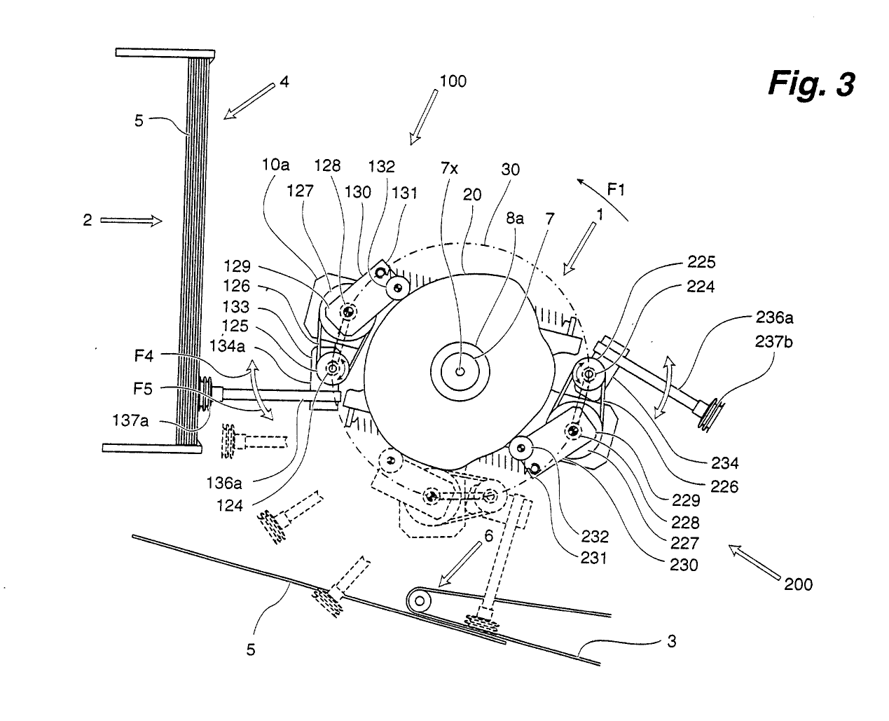

FIG. 3 is a schematic lateral view according to the line 3-3 in FIG. 2;

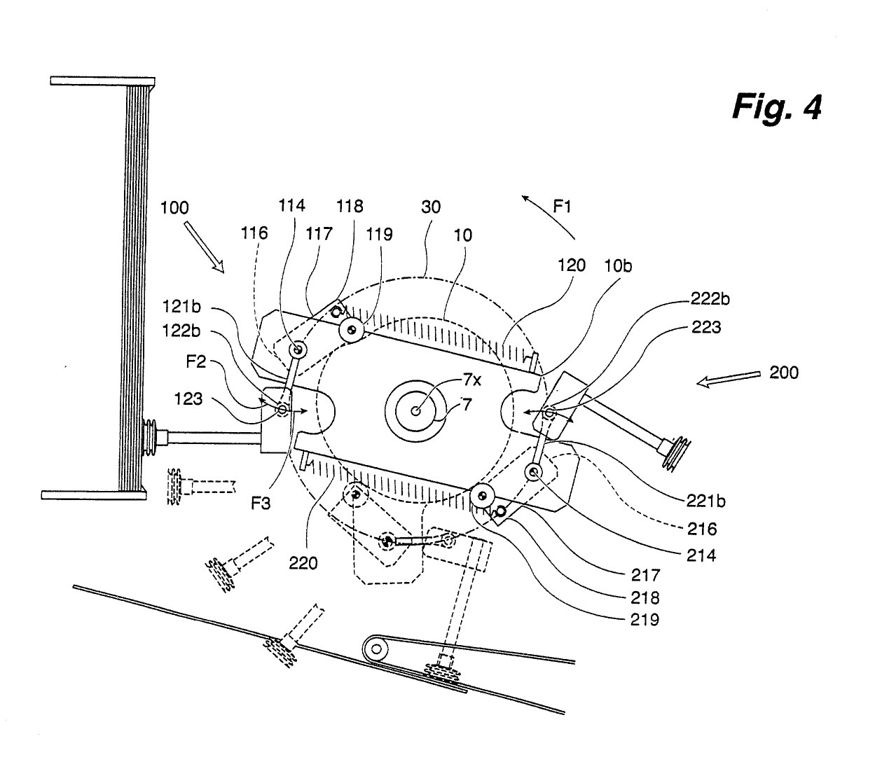

FIG. 4 is a schematic lateral view with reference to the line 4-4 in FIG. 2; and

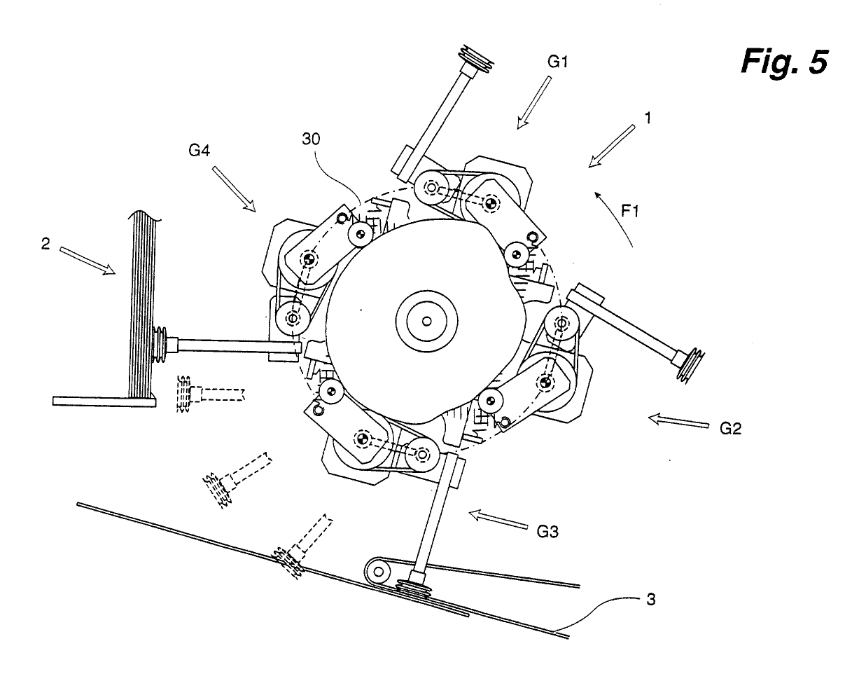

FIG. 5 is a schematic lateral view similar to FIG. 3 illustrating a variant embodiment.

With reference to the aforementioned figures, see in particular FIG. 3, the device 1 which is the subject of the present invention is disposed between a collection store 2 for cardboars blanks 5 and a receipt conveyor 3, illustrated here schematically, wherein, substantially and by way of example, the said store 1 presents in the vicinity of its downstream end 4 the flat cardboard blanks 5 themselves for collection, and the said conveyor 3 receives the cardboard blanks 5 themselves in the vicinity of its lower upstream portion 6, using for example a suction belt-type conveyor.

Substantially, see in particular FIGS. 1 and 2, the said device 1 has a first central shaft 7, which is supported such as to rotate idly by means of two tubes 8a and 8b, which are secured to two opposite shoulders 9a and 9b, presented by the machine frame.

The said first shaft 7 has secured to it a first and a second plate-type rotary element 10a and 10b which extend radially, are disposed facing and axially spaced from one another, designed to support two gripper units 100 and 200 which are described in greater detail hereinafter, disposed opposite one another, as well as a driven toothed wheel 11, which is disposed adjacent to the tube 8a and is keyed onto the said first shaft 7, around which there is wound a chain 12, wherein the latter is also wound around a motorised wheel for a chain 13.

In the vicinity of their outer perimeter, in opposite positions, the two rotary elements 10a and 10b support such as to rotate idly two second shafts 114 and 214, which are designed to move along a circumferential orbital path indicated as 30 in FIGS. 3 and 4.

The said second shafts 114 and 214, see FIG. 2, have respective right ends 115 and 215 which extend beyond the outer side of the rotary element 10b, which have secured to them respective first ends 116 and 216, see also FIG. 4, of respective levers 117 and 217, which have at their second opposite ends 118 and 218 respective cam-follower rollers 119 and 219, which rotate idly and are designed to run along the profile of a common first stationary disc-type cam 10, with the assistance of respective return springs 120 and 220, wherein the said first stationary disc-type cam is secured to the shoulder 9b of the machine frame.

Each of the said second opposite shafts 114 and 214 has a plurality of respective arms 121a,121b and 221a,221b, which extend radially relative to the said second shafts 114 and 214, wherein the said arms 121a,121b and 221a, 221b have their respective first proximal ends secured radially onto the respective second shafts 114 and 214, and their second opposite distal ends designed to form circular eyelets 122a, 122b and 222a,222b, wherein the said latter are designed to support respective third shafts 123 and 223 such that the latter rotate idly.

The said third shafts 123 and 223, see FIG. 2, have respective left portions 124 and 224 which extend axially beyond the outer side of the rotary element 10a and are designed to support keyed onto them respective driven toothed wheels 125 and 225, around which there are wound respective chains or toothed belts 126 and 226, wherein the said latter are also wound around respective toothed drive wheels 127 and 227, which are supported such as to rotate idly by the said first rotary element 10a, for example, see FIG. 2, by means of respective shafts 128 and 228, which are disposed coaxially relative to the said second shafts 114 and 214, wherein the said shafts 128 and 228 in the form illustrated here by way of example are supported axially in a projecting manner by means of respective supports 140 and 240 secured to the left-hand side of the first rotary element 10a.

The said wheels 127 and 227, see also FIG. 3, have secured to them respective first ends 129 and 229 of respective levers 130 and 230, which have at their second opposite ends 131 and 231 respective cam-follower rollers 132 and 232, which rotate idly, and are designed to run along the profile of a common second stationary-disc cam 20, which is secured to the shoulder 9a of the machine frame.

The said third shafts 123 and 223, see in particular FIG. 1, have secured to them the first proximal ends 133a, 133b etc and 233a, 233b etc of respective clamps 134a, 134b etc and 234a, 234b etc which extend radially, the respective second distal opposite ends of which 135a, 135b and 235a, 235b etc have secured to them the first proximal ends of respective hollow legs 136a, 136b etc and 236a, 236b etc, which have tangential orientation relative to the said third shafts 123 and 223, wherein the second opposite distal ends of the said legs have respective gripper means, in this case suckers 137a, 137b etc and 237a, 237b etc, which are fitted axially onto the free ends of the said legs and communicate with their axial duct.

The suckers themselves 137a, 137b etc and 237a, 237b etc, see FIG. 1, are made to suck or not to suck by command, for example by means of respective single or multiple ducts 138, 139 and 238, 239, which have a distal end connected to the hollow legs 136a etc and 236a etc of the corresponding suckers 137a etc 237a etc, and a proximal end which is connected to one or more respective connection parts disposed on the rotary element 10b and/or on the rotary element 10a, in order to obtain pneumatic distribution which can take place mechanically and/or electrically and/or electronically, and is not described here in detail since it is known.

The said clamps 134a, 134b etc and 234a, 234b etc can also be repositioned along the axial extension of the respective third shafts 123 and 223, and similarly the respective legs 136a, 136b etc and 236a, 236b etc can be repositioned axially relative to the respective clamps 134a, 134b etc and 234a, 234b etc.

With reference to the above structural description, by means of rotation of the first shaft 7, there is rotation of the two rotary elements 10a and 10b, with consequent orbiting of the two gripper units 100 and 200.

More particularly, the rotation of the two rotary elements 10a and 10b, which takes place in the direction F1, gives rise to the translation of the two second opposite shafts 114 and 214 along a circumferential orbit indicated as 30 in FIGS. 3 and 4, wherein, in addition, during their orbital path, the said second two opposite shafts 114 and 214 are made to oscillate relative to their own axis 114x and 214x, by means of first oscillator means 117, 119 and 217 and 219, which are activated by means of the first stationary cam 10, wherein the said first oscillator means comprise respectively the levers 117 and 217 and the respective cam-follower rollers 119 and 219.

The said oscillation of the second two shafts 114 and 214 changes the inclination of the respective arms 121a, 121b and 221a, 221b, giving rise to displacement of the respective third shafts 123 and 223, see FIG. 4, in the direction F2 or F3, which gives rise to distancing or approach of the said two third shafts 123 and 223 relative to the first shaft 7, i.e. relative to the centre of rotation 7x.

Again during the rotation of the said two rotary elements 10a and 10b, the said third shafts 123 and 223 are made to oscillate relative to their own axes 123x and 223x by means of second oscillator means 125, 126, 127, 130, 132 and 225, 226, 227, 230, 232, which are actuated by means of the second stationary cam 20, wherein the said second oscillator means comprise respectively the driven wheels 125 and 225, the belts 126 and 226, the drive wheels 127 and 227, the levers 130 and 230, and the cam-follower rollers 132 and 232.

The controlled rotation of the two third shafts 123 and 223 gives rise to oscillation of the respective clamps 134a, 134b etc and 234a, 234b etc relative to the respective centre of oscillation 123x and 223x, with consequent change of the inclination of the respective legs 136a, 136b etc and 236a, 236b etc, and thus of the corresponding suckers 137a, 137b etc and 237a, 237b etc, thus making it possible to obtain optimum orientation of the gripping plane configured by the free ends of the said suckers during their orbital translation, i.e. in the directions F4 and F5 indicated in FIG. 3.

Thus, by way of example, during the rotation with continuous motion of the shaft 7 and of the two rotary elements 10a and 10b in the direction F1, by means of the first oscillator means 117, 119 and the cam 10, the suckers 137a, 137b etc, see FIG. 4, are moved in the direction F2 against the cardboard blanks 5 disposed further downstream in the store 2, and simultaneously, by means of the second oscillator means 125, 126, 127, 130, 132 and the cam 20, the suckers themselves 137a, 137b etc, see FIG. 3, are moved in the direction F4 in order to obtain a pause and optimise the contact and gripping.

After this, again see FIGS. 3 and 4, the cardboard blanks thus grasped are extracted from the store 2, giving rise to displacement in the direction F3 in order to extract the cardboard blanks 5, and are then translated to the conveyor 3, in order then to support the upper surface of the front portion of the cardboard blanks 5 themselves against the lower surface of the upstream portion 6 of the suction belt conveyor 3 itself, with calibration by means of the cams 10 and 20 of the rotations of the second and third shafts 114, 123 and 214, 223, such as to optimise the step of approach and release of the cardboard blanks 5 onto the said conveyor 3, during this step keeping for example the gripping plane of the suction suckers 137a, 137b etc and 237a, 237b etc parallel to the lower stop and gripping surface of the conveyor 6, wherein, more particularly, the suckers 137a and 137b etc and the suckers 237a and 237b have between them an axial distance which is slightly greater than the transverse amplitude of the conveyor 3, in order to pass adjacent to the transversely opposite sides of the conveyor 3 itself, as described and illustrated substantially in another patent application for an industrial invention, number EP-01.105633, filed in the name of the same applicant as the present patent application.

Finally, with reference to the above description, it is apparent that the said device 1 can equivalently have a single orbiting gripper unit or two or more orbiting gripper units, without departing from the inventive concepts which are expressed and protected in the present invention.

If it is wished to use a plurality of gripper units, it is preferable to place the said units circumferentially equidistantly relative to the circumferential path 30, such as in the example illustrated in FIG. 5, in which there are provided four gripper units G1, G2, G3, G4 similar to those previously described.

The description of the device for collection, translation and release of cardboard blanks in individual succession is provided purely by way of non-limiting example, and therefore all modifications and variations suggested by practice and by its utilisation or use can be made to it, within the context of the scope of the following claims.

1)-Device for collection, translation and supply of flat cardboard blanks (5) from a collection store (2) to a receipt conveyor (3), wherein the said device comprises:
two rotary elements (10a and 10b) which are disposed opposite one another and are designed to rotate relative to a first shaft (7) which is disposed between the said store (1) and the said conveyor (3);
one or more gripper units (100, 200) which are supported by the said two rotary elements (10a, 10b) and are designed to move along an orbit which passes in the vicinity of the said store (1) and in the vicinity of the said conveyor (3), characterised in that each of the said gripper units (100, 200) comprises:
a second shaft (114) which is supported such as to rotate idly by the said two rotary elements (10a, 10b), and is designed to orbit along a circumferential path (30), wherein the said second shaft (114) is oscillated by command relative to its own axis (114x) by means of first oscillator means (117, 119) which are activated by means of a first stationary cam (10);
a third shaft (123) which is supported such as to rotate idly by means of two or more arms (121a, 121b) which are secured to the said shaft (114) and extend radially, wherein the said third shaft (123) is oscillated by command relative to its own axis (123x) by means of second oscillator means (125, 126, 127, 130, 132) which are activated by means of a second stationary cam (20);
one or more gripper means (137a) which are supported by the said third shaft.

2)-Device according to claim 1, characterised in that the said first oscillator means (117, 119) comprise a lever (117) which has a first end (116) secured to an end (115) of the said second shaft (114) and a second opposite end (118) which is designed to support a cam-follower roller (119) which is designed to follow the profile of the said first stationary cam (10).

3)-Device according to claim 2, characterised in that the said end (116) of the second shaft (114) extends axially beyond the outer side of one (10b) of the said rotary elements (10a, 10b) and in that the said first stationary cam (10) is disposed on the same outer side as the said rotary element (10b).

4)-Device according to one of the preceding claims, characterised in that the said second oscillator means (125, 126, 127, 130, 132) comprise:
a driven wheel (125) which is secured to one end (124) of the said third shaft (123);
a drive wheel (127) which is supported such as to rotate idly by one (10a) of the said two rotary elements (10a, 10b);
a belt (126) which is wound around the said driven wheel (125) and around the said drive wheel (127);
a lever (130) which has a first end (129) secured to the said drive wheel (127) and a second opposite end (131) which is designed to support a cam-follower roller (132) which is designed to follow the profile of the said second stationary cam (20).

5)-Device according to claim 4, characterised in that the said end (124) of the third shaft (123) extends axially beyond the outer side of one (10a) of the said rotary elements (10a, 10b) and in that the said second stationary cam (20) is disposed on the same outer side of the aforementioned rotary element (10a).

6)-Device according to claim 4, characterised in that the said drive wheel (127) is supported such as to rotate idly by means of a shaft (128) presented by a support (129) which is secured to the outer side of the aforementioned rotary element (10a).

7)-Device according to claim 4, characterised in that the said drive wheel (127) is supported such as to rotate idly on a shaft (128) which is disposed coaxially relative to the said second shaft (114).

8)-Device according to claim 1, characterised in that the said one or more gripper means (137) is/are supported by the said third shaft (123) by means of respective clamps (134a, 134b etc) which extend radially relative to the said third shaft (123), in that the first proximal ends (133a, 133b etc) of the said clamps (134, 134b etc) are secured to the third shaft and in that the second distal ends (135a, 135b etc) of the said clamps (134, 134b etc) are designed to have secured to them the legs (136a, 136b etc) of respective suckers (137a, 137b etc).

9)-Device according to claim 8, characterised in that the said legs (136a, 136b etc) have an orientation which is tangential relative to the third shaft (123).

10)-Device according to claim 8, characterised in that the said clamps (134a, 134b etc) can be repositioned along the axial extension of the third shaft (123).

11)-Device according to claim 8, characterised in that the said legs (136a, 136b etc) can be repositioned along their own axis relative to the corresponding clamps (134a, 134b etc).

12)-Device according to any one of the preceding claims, characterised in that it comprises two gripper units (100, 200) which are supported by the said two rotary elements (10a, 10b) and are disposed circumferentially equidistantly in a manner opposite to one another.

13)-Device according to any one of the preceding claims, characterised in that it comprises a plurality of gripper units (G1, G2, G3, G4) which are supported by the said two rotary elements (10a, 10b) and in that the said gripper units are disposed circumferentially equidistantly.
